(19) United States
(12) Patent Application Publication
(10) Pub. No.: US 2025/0054177 A1
(43) Pub. Date: Feb. 13, 2025

(54) APPARATUS FOR TRACKING OBJECT AND OPERATING METHOD THEREOF

(71) Applicants: Hundai Motor Company, Seoul (KR); Kia Corporation, Seoul (KR)

(72) Inventors: Hyun Jun Kim, Seoul (KR); Jun Sik An, Seoul (KR)

(21) Appl. No.: 18/517,733

(22) Filed: Nov. 22, 2023

(30) Foreign Application Priority Data
Aug. 9, 2023 (KR) 10-2023-0104285

(51) Int. Cl. G06T 7/70; G06T 3/40; G06V 10/44; G06V 10/62; G06V 10/74

(52) U.S. Cl. CPC G06T 7/70; G06T 3/40; G06V 10/44; G06V 10/62; G06V 10/761

(57) ABSTRACT

A device is introduced for object tracking. The device may comprise a processor, and memory storing instructions that, when executed by the processor, may cause the device to: receive a first resolution image associated with a first time and comprising an interest object, generate a second resolution image, determine a second resolution feature of the interest object, determine interest object information may comprise location information of the interest object, determine a first resolution feature associated with a region of the first resolution image, output time appearance information indicating an appearance of the interest object associated with the first time, track an operation state of the interest object, wherein the past time appearance information indicates an appearance of the interest object associated with a second time that is before the first time, and output a signal to control operation of a second device.

### CROSS-REFERENCE TO RELATED APPLICATION

This application claims the benefit of priority to Korean Patent Application No. 10-2023-0104285, filed in the Korean Intellectual Property Office on Aug. 9, 2023, the entire contents of which are incorporated herein by reference.

### TECHNICAL FIELD

The present disclosure relates to an object tracking device and an operating method thereof.

### BACKGROUND

As a part of an autonomous driving technology, various sensors may be mounted in a vehicle. The sensors mounted in the vehicle may include a camera, light detection and ranging (LiDAR), an ultrasonic sensor, etc. An autonomous vehicle may avoid the collision with surrounding objects by using various sensors and may stably perform autonomous driving.

For the safe driving of the autonomous vehicle, an objecting tracking technology capable of detecting objects around the vehicle and tracking the movement of the objects may be used with the camera. A detector capable of detecting an interest object may be used as a device that is utilized in the object tracking technology. The detector may recognize an interest object in an image captured through the camera by using a deep learning-based neural network.

As the performance of the camera mounted in the vehicle is improved, a higher-definition image may be obtained. However, if a higher-resolution image is input to the detector, a lot of resources are used, which makes it impractical to obtain a complete output value through a neural network.

In contrast, if an object is detected by using a lower-resolution image, information about an object existing far away with respect to the field of view of the camera may be lost due to the low resolution. In this case, features of the distant object may not be accurately extracted.

In addition, using only an intersection over union (IoU) and a Mahalanobis distance may not be effective to track the movement of an object(s) based on a location change of the object(s) detected in each of image frames. The IoU and the Mahalanovis distance refer to a technique for tracking an object based on a location change of the object in each of the image frames. Because, if a plurality of objects overlap each other in each of the image frames, identifiers respectively allocated to the plurality of objects may be switched or mixed up.

### SUMMARY

According to the present disclosure, a device may comprise: a processor, and memory storing instructions that, when executed by the processor, may cause the device to: receive a first resolution image associated with a first time and comprising an interest object, generate, based on the first resolution image, a second resolution image, determine, based on the second resolution image, a second resolution feature of the interest object, determine, based on the second resolution feature, interest object information may comprise location information of the interest object, determine, based on the location information, a first resolution feature associated with a region of the first resolution image, output, based on the first resolution feature and the second resolution feature, time appearance information indicating an appearance of the interest object associated with the first time, track an operation state of the interest object based on the time appearance information and past time appearance information, wherein the past time appearance information indicates an appearance of the interest object associated with a second time that is before the first time, and output, based on the tracked operation state of the interest object, a signal to control operation of a second device.

The device, wherein the instructions, when executed by the processor, may cause the device to output the time appearance information by applying a pooling operation to the first resolution feature and the second resolution feature. The device, wherein the instructions, when executed by the processor, may cause the device to: determine, based on similarity between the time appearance information and the past time appearance information, whether the interest object is the same as a previously recognized object at the second time, and track, based on the determination that the interest object is the same, the operation state of the interest object.

The device, wherein the instructions, when executed by the processor, may cause the device to: determine, based on cosine similarity between the time appearance information and the past time appearance information, whether the interest object is the same as the previously recognized object.

The device, wherein the instructions, when executed by the processor, may cause the device to: determine whether the interest object is the same as the previously recognized object, based on at least one of an intersection over union (IoU), a Mahalanobis distance, or cosine similarity.

The device, wherein the instructions, when executed by the processor, may cause the device to: allocate a new identifier (ID) to the interest object based on the interest object being different from the previously recognized object or based on the interest object not being previously recognized, and track, based on the new ID, the operation state of the interest object.

The device, wherein the instructions, when executed by the processor, may cause the device to: acquire the second resolution image by adjusting a resolution of the first resolution image. The device, wherein the instructions, when executed by the processor, may cause the device to: determine, based on the location information and based on a ratio of a size of the second resolution image to a size of the first resolution image, the region of the first resolution image.

According to the present disclosure, a method may comprise: receiving a first resolution image associated with a first time and comprising an interest object, generating, based on the first resolution image, a second resolution image, determining, based on the second resolution image, a second resolution feature associated with the interest object, determining, based on the second resolution feature, interest object information may comprise location information of the interest object, determining, based on the location information, a first resolution feature associated with a region of the first resolution image, outputting, based on the first resolution feature and the second resolution feature, time appearance information indicating an appearance of the interest object associated with the first time, tracking an operation state of the interest object based on the time appearance information and past time appearance information, wherein the past appearance time information indicates an appearance of the interest object associated with a second time that is before the first time, and outputting, based on the tracking the operation state of the interest object, a signal to control operation of a device.

The method, wherein the outputting the time appearance information may comprise: applying a pooling operation to the first resolution feature and the second resolution feature. The method, further may comprise: determining, based on similarity between the time appearance information and the past time appearance information, whether the interest object is the same as a previously recognized object, wherein the tracking the operation state of the interest object may comprise: tracking, based on the determining, the operation state of the interest object.

The method, wherein the determining whether the interest object is the same as the previously recognized object may comprise: determining, based on cosine similarity between the time appearance information and the past time appearance information, whether the interest object is the same as the previously recognized object.

The method, wherein determining whether the interest object is the same as the previously recognized object may comprise: determining whether the interest object is the same as the previously recognized object, based on at least one of an intersection over union (IoU), a Mahalanobis distance, or cosine similarity.

The method, may further comprise: allocating a new identifier (ID) to the interest object based on at least one of: the interest object being different from the previously recognized object or the interest object not being previously recognized. The method, wherein the receiving the second resolution image may comprise: adjusting a resolution of the first resolution image. The method, may further comprise: determining, based on the location information and based on a ratio of a size of the second resolution image to a size of the first resolution image, the region of the first resolution image.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an object tracking device according to an example of the present disclosure;

FIG. 2 shows an example of a method in which an object tracking device acquires a first resolution image and a second resolution image, according to an example of the present disclosure;

FIG. 3 shows an example of a method in which an object tracking device generates a first resolution feature and a second resolution feature, according to an example of the present disclosure;

FIG. 4 shows an example of a method in which an object tracking device outputs specific time appearance information using an average pooling operation, according to an example of the present disclosure;

FIG. 5 shows an example of a cost matrix according to an example of the present disclosure; and

FIG. 6 shows an example of an operation method of an object tracking device according to an example of the present disclosure.

### DETAILED DESCRIPTION

Hereinafter, examples of the present disclosure may be described with reference to accompanying drawings. However, those of ordinary skill in the art will recognize that modification, equivalent, and/or alternative on various examples described herein can be variously made without departing from the scope and spirit of the present disclosure.

Examples of the present disclosure and terms used herein are not intended to limit the technical features described in the present disclosure to specific examples, and it should be understood that the examples and the terms include modification, equivalent, or alternative on the corresponding examples described herein. With regard to description of drawings, similar or related components may be marked by similar reference marks/numerals. The singular form of the noun corresponding to an item may include one or more of items, unless interpreted otherwise in context.

In the present disclosure, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first”, “second”, “A”, “B”, “(a)”, or “(b)” may be used to simply component from the other distinguish the corresponding component, but do not limit the corresponding components in other examples (e.g., importance or order) unless specifically stated to the contrary.

In this specification, if a component (e.g., a first component) is referred to as being “coupled with/to” or “connected with/to” another component (e.g., a second component) with or without the term of “operatively” or “communicatively”, it may mean that a component is connectable to the other component, directly (e.g., by wire or wirelessly), or indirectly (e.g., through the third component).

A method according to various examples disclosed in the specification may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store, directly between two user devices, or online. In the case of on-line distribution, at least part of the computer program product may be at least temporarily stored in the machine-readable storage medium such as the memory of a manufacturer's server, an application store's server, or a relay server or may be generated temporarily.

According to examples disclosed in the specification, each component (e.g., a module or a program) of the above-described components may include a single entity or a plurality of entities, and some of the plurality of objects may be separately arranged on other components. According to examples disclosed in the specification, one or more components of the above-described components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to examples disclosed in the specification, operations executed by modules, programs, or other components may be executed by a successive method, a parallel method, a repeated method, or a heuristic method. Alternatively or additionally, at least one or more of the operations may be executed in another order or may be omitted, or one or more operations may be added.

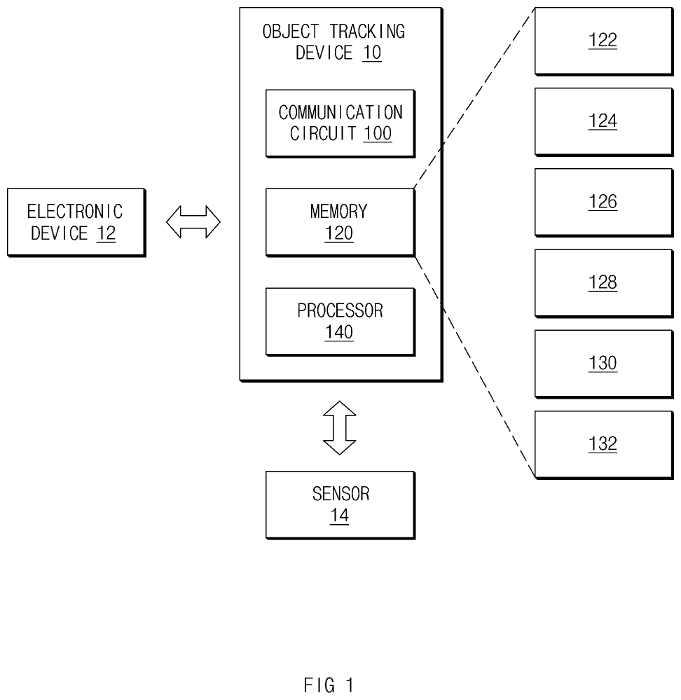

FIG. 1 shows an example of an object tracking device 10 according to an example of the present disclosure.

Referring to FIG. 1, the object tracking device 10 may be connected to an electronic device 12 and a sensor 14 in a wireless and/or wired manner.

In an example, the connection between the object tracking device 10 and the electronic device 12 may include a communication connection that is made through a wired and/or wireless network. In an example, the wired network may be based on local area network (LAN) communication or power line communication. In an example, the wireless network may be based on a short-range communication network (e.g., Bluetooth, wireless fidelity (Wi-Fi), or infrared data association (IrDA)) or a long-range communication network (e.g., a cellular network, a 4G network, or a 5G network).

In another example, the connection between the object tracking device 10 and the electronic device 12 may include a connection that is made through a device-to-device communication manner (e.g., a bus, a general purpose input and output (GPIO), a serial peripheral interface (SPI), or a mobile industry processor interface (MIPI)).

In an example, the electronic device 12 may include a mobile device (e.g., a mobile phone, a laptop computer, a smartphone, or a smart pad) or an electric vehicle (e.g., an electric vehicle (EV), a hybrid EV (HEV), a plug-in HEV (PHEV), or a fuel cell EV (FCEV)).

In an example, the connection between the object tracking device 10 and the sensor 14 may include a communication connection that is made through a wired and/or wireless network.

In an example, the sensor 14 may be implemented with a camera, radio detection and ranging (Radar), light detection and ranging (LIDAR), an ultrasonic sensor, or a combination thereof. According to examples, the sensor 14 may be included in the electronic device 12 or the object tracking device 10. Below, the description will be given under the assumption that the sensor 14 is implemented with a camera.

The object tracking 10 device may include a communication circuit 100, a memory 120, a processor 140, or a combination thereof. According to an example, the object tracking device 10 illustrated in FIG. 1 may further include at least one component (e.g., a display, an input device, an output device, or the sensor 14) in addition or alternative to the components illustrated in FIG. 1.

In an example, the communication circuit 100 may establish a wired communication channel and/or a wireless communication channel between the object tracking device 10 and the electronic device 12 and/or between the object tracking device 10 and the sensor 14 and may transmit/receive data to/from the electronic device 12 and/or the sensor 14 through the established communication channel.

The memory 120 may store data that are used by at least one component (e.g., the processor 140) of the object tracking device 10. For example, the data may include software (or an instruction associated with the software), input data, or output data. In an example, the instruction may cause, when executed by the processor 140, the object tracking device 10 to perform operations defined by the instruction.

In an example, the memory 120 may include a volatile memory and/or a nonvolatile memory.

In an example, the memory 120 may include one or more software (e.g., a first resolution image acquisition device 122, a second resolution image acquisition device 124, an interest object information generator 126, a first resolution feature generator 128, an appearance information output device 130, an object tracker 132, or a combination thereof).

The processor 140 may execute the software (e.g., the first resolution image acquisition device 122, the second resolution image acquisition device 124, the interest object information generator 126, the first resolution feature generator 128, the appearance information output device 130, the object tracker 132, or a combination thereof) to control at least another component of the object tracking device 10 connected to the processor 140 and to perform various data processing or computation (or calculation).

In an example, the processor 140 may include a central processing unit, an application processor, a graphic processing unit, a neural processing unit (NPU), an image signal processor, a sensor hub processor, or a communication processor.

Each of the plurality of software (e.g., the first resolution image acquisition device 122, the second resolution image acquisition device 124, the interest object information generator 126, the first resolution feature generator 128, the appearance information output device 130, the object tracker 132, or a combination thereof) stored in the memory 120 may be software that performs some of operations to be performed by one neural network model. Below, the description will be given under the assumption that the neural network is a convolutional neural network (CNN). This is for convenience of description, and the neural network is not limited to the convolution neural network.

Below, a method in which the object tracking device 10 tracks one or more interest objects through the first resolution image acquisition device 122, the second resolution image acquisition device 124, the interest object information generator 126, the first resolution feature generator 128, the appearance information output device 130, and the object tracker 132 will be described.

The first resolution image acquisition device 122 may acquire a first resolution image. The first resolution image acquisition device 122 may acquire the first resolution image in which an interest object captured at a specific point in time is included. The first resolution image acquisition device 122 may acquire the first resolution image captured around the vehicle by using the camera (or including information about an ambient environment of the vehicle captured by using the camera). Herein, the first resolution image may refer to an image whose resolution is higher than that of a second resolution image to be described later. The specific point in time may mean a specified time or a current time.

The second resolution image acquisition device 124 may acquire the second resolution image. The second resolution image acquisition device 124 may acquire the second resolution image corresponding to the first resolution image. The second resolution image acquisition device 124 may acquire the second resolution image in which the interest object captured at the specific point in time is included. Herein, the “second resolution image corresponding to the first resolution image” may be an image having only a resolution difference with the first resolution image. A second resolution of the second resolution image may be lower than a first resolution of the first resolution image.

In an example, the second resolution image acquisition device 124 may acquire the second resolution image resolution by adjusting the resolution of the first resolution image. The second resolution image acquisition device 124 may acquire the second resolution image by adjusting the size of the first resolution image.

In an example, the second resolution image acquisition device 124 may acquire the second resolution image captured around the vehicle by using the camera (or including information about the ambient environment of the vehicle captured by using the camera).

The interest object information generator 126 may generate a second resolution feature associated with the interest object based on the second resolution image. Herein, the second resolution feature may refer to a feature map including a feature of the interest object extracted from the second resolution image.

The interest object information generator 126 may generate interest object information including location information of the interest object based on the second resolution feature. Herein, the interest object information may include location information and classification information of the interest object. The location information may indicate a coordinate value for extracting a specific region in an image frame. The location information may indicate a coordinate value of a bounding box including the interest object in the image frame of the specific point in time. The classification information may indicate information for specifying a kind of the interest object depending on an item classified in advance.

The first resolution feature generator 128 may generate a first resolution feature associated with the specific region in the first resolution image, which corresponds to the location information of the second resolution image. The first resolution feature generator 128 may generate the first resolution feature associated with the specific region in the first resolution image, which corresponds to a coordinate value of a bounding box including the interest object in the second resolution image. Herein, the first resolution feature may refer to a feature map including a feature of the interest object extracted from the first resolution image. The specific region may be a region where the location information in the second resolution image is applied to the first resolution image based on a result of converting the location information depending on a ratio of the size of the second resolution image to the size of the first resolution image.

In an example, the first resolution feature generator 128 may be included in the interest object information generator 126.

The appearance information output device 130 may output appearance information of the interest object based on the first resolution feature and the second resolution feature. The appearance information output device 130 may output specific time appearance information of the interest object based on the first resolution feature and the second resolution feature. Herein, the specific time appearance information may refer to a feature vector associated with an appearance feature of the interest object in the image frame acquired at the specific point in time.

In an example, the appearance information output device 130 may output the specific time appearance information by applying a pooling operation to the first resolution feature and the second resolution feature.

In an example, the appearance information output device 130 may output the specific time appearance information by using an average pooling operation that is performed based on the first resolution feature and the second resolution feature. Herein, the average pooling operation may refer to an operation that is performed in a pooling layer of a CNN neural network structure and is used to extract partial data from the feature map based on an average value in a window.

In an example, the appearance information output device 130 may output the specific time appearance information by using a max pooling operation that is performed based on the first resolution feature and the second resolution feature. Herein, the max pooling operation may refer to an operation that is performed in the pooling layer of the CNN neural network structure and is used to extract partial data from the feature map based on a maximum value in a window.

The object tracker 132 may track an operation state of the interest object based on the specific time appearance information and past time appearance information corresponding to a past point in time before the specific point in time. Herein the past point in time may be a point in time before the specific point in time. The past time appearance information may refer to a feature map associated with appearance features of one or more interest objects recognized in the image frame acquired before the specific point in time. The past time appearance information may be information generated from a past image frame depending on the process of outputting the specific time appearance information described above.

The object tracker 132 may determine whether the interest object is the same as a previously recognized object. The object tracker 132 may determine whether the interest object is the same as the previously recognized object, based on the similarity between the specific time appearance information and the past time appearance information. The object tracker 132 may determine whether the interest object is the same as the previously recognized object corresponding to the past time appearance information, based on the similarity between the specific time appearance information and the past time appearance information. Herein, the previously recognized object may include one or more interest objects recognized at the past point in time.

In an example, the object tracker 132 may determine whether the interest object is the same as the previously recognized object, based on an inner product of the feature vector of the specific time appearance information and the feature vector of the past time appearance information. The object tracker 132 may determine whether the interest object is the same as the previously recognized object, based on the cosine similarity between the feature vector of the specific time appearance information and the feature vector of the past time appearance information. Herein, the cosine similarity may be expressed by Equation 1 below.

$$cos ( θ ) = \frac{{f}_{t} \cdot {f}_{t - 1}}{\vert {f}_{t} \vert \vert {f}_{t - 1} \vert} \qquad [ Equation 1 ]$$

In Equation 1 above, ft represents the feature vector of the specific time appearance information, and fₜ₋₁ represents the feature vector of the past time appearance information.

In an example, the object tracker 132 may determine whether the interest object is the same as the previously recognized object, based on a cost matrix. The object tracker 132 may determine whether the interest object is the same as the previously recognized object, based on the cost matrix including cost values that are based on at least one of the intersection over union (IoU), the Mahalanobis distance, and the cosine similarity. Herein, the cost matrix may be a matrix including a plurality of cost values based on one or more variables. The IoU may be an index for checking how much a region at the specific point in time and a region at the past point in time overlap each other. The Mahalanobis distance may mean a distance between two objects selected in consideration of a correlation between the plurality of variables. As the object tracker 132 further considers the cosine similarity in addition or alternative to the IoU and the Mahalanobis distance, the object tracker 132 may accurately distinguish a plurality of objects even in a situation where the plurality of objects overlap each other in the image frame of the past point in time or the image frame at the specific point in time. A cost value may be expressed by Equation 2 below.

$${C}_{ij} = λ \cdot {d}_{1} ( i , j ) + ( 1 - λ ) \cdot {d}_{2} ( i , j ) \qquad [ Equation 2 ]$$

In Equation 2 above, “i” represents an identifier of an object detected at the specific point in time, and “j” represents an identifier of an object detected at the past point in time. Cᵢⱼ is a cost value between an i-th object of the specific point in time and an i-th object of the past point in time, d₁(i,j) is a Mahalanobis distance between the i-th object of the specific point in time and the i-th object of the past point in time, and d₂(i,j) is a cosine similarity between the i-th object of the specific point in time and the i-th object of the past point in time.

The object tracker 132 may track an operation state of the interest object. The object tracker 132 may track the operation state of the interest object based on a result of determining whether the interest object is the same as the previously recognized object.

In an example, if the interest object is the same as the previously recognized object, the object tracker 132 may update an operation state of the previously recognized object. For example, if it is determined that the interest object is the same as the previously recognized object, the object tracker 132 may update a location of the interest object of the past point in time so as to be changed to a location of the interest object of the specific point in time.

In an example, if the interest object is different from the previously recognized object or if there is no object recognized at the past point in time, the object tracker 132 may allocate a new identifier (ID) to the interest object. The object tracker 132 may track the operation state of the interest object to which the new identifier is allocated.

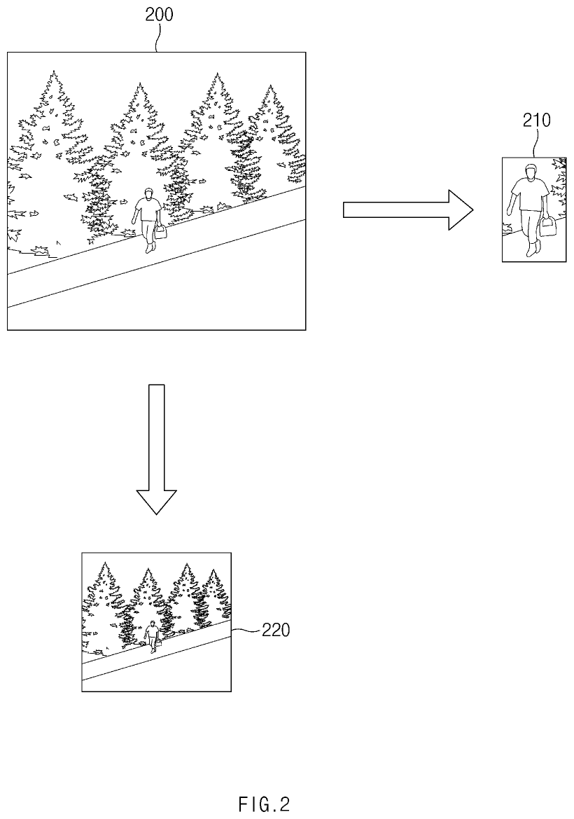

FIG. 2 shows an example of a method in which the object tracking device 10 acquires a first resolution image 200 and a second resolution image 220, according to an example of the present disclosure.

Referring to FIG. 2, the object tracking device 10 may acquire the first resolution image 200 captured through the sensor 14. The object tracking device 10 may acquire the first resolution image 200 captured through the camera. The object tracking device 10 may acquire the first resolution image 200 through the first resolution image acquisition device 122.

The second resolution image acquisition device 124 may acquire the second resolution image 220. In an example, the second resolution image acquisition device 124 may acquire the second resolution image 220 captured through the sensor 14. The second resolution image acquisition device 124 may acquire the second resolution image 220 captured through the camera. In an example, the second resolution image acquisition device 124 may acquire the second resolution image 220 by adjusting the resolution of the first resolution image 200. The second resolution image acquisition device 124 may acquire the second resolution image 220 by adjusting the size of the first resolution image 200.

The interest object information generator 126 may generate interest object information including location information of an interest object based on a second resolution feature.

The first resolution feature generator 128 may extract a specific region 210 from the first resolution image 200 based on the location information of the second resolution image 220. The first resolution feature generator 128 may crop the specific region 210 from the first resolution image 200 based on the location information of the second resolution image 220.

The first resolution feature generator 128 may crop the specific region 210 from the first resolution image 200, which corresponds to a coordinate value of a bounding box including the interest object in the second resolution image.

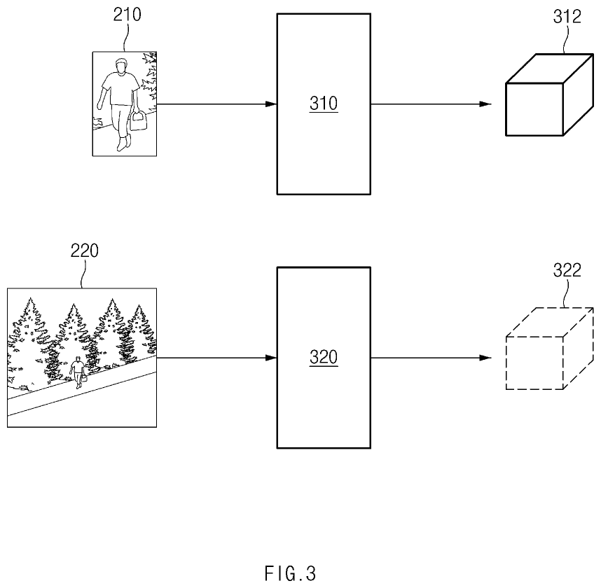

FIG. 3 shows an example of a method in which the object tracking device 10 acquires a first resolution feature 312 and a second resolution feature 322, according to an example of the present disclosure.

Referring to FIG. 3, the first resolution feature generator 128 may generate the first resolution feature 312 based on the specific region 210 of the first resolution image 200. The first resolution feature generator 128 may generate the first resolution feature 312 by applying a convolution operation to the specific region 210. The first resolution feature generator 128 may generate the first resolution feature 312 by using a first convolution layer 310. Herein, the first resolution feature generator 128 may include a backbone (e.g., an encoder), a neck that extracts a scale-specific head, and a head that collects plural features thus extracted and outputs a final output value.

The interest object information generator 126 may generate the second resolution feature 322 based on the second resolution image 220. The interest object information generator 126 may generate the second resolution feature 322 by applying the convolution operation to the second resolution image 220. The interest object information generator 126 may generate the second resolution feature 322 by using a second convolution layer 320.

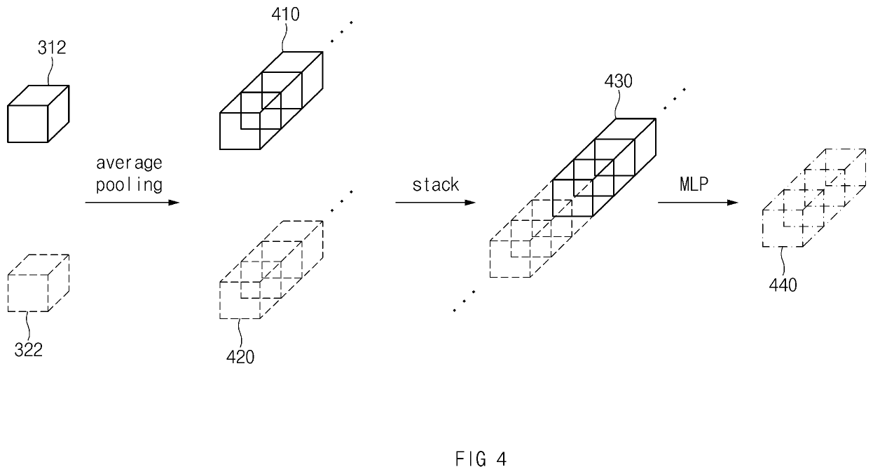

FIG. 4 shows an example of a method in which the object tracking device 10 outputs specific time appearance information by using an average pooling operation, according to an example of the present disclosure.

Referring to FIG. 4, the object tracking device 10 may generate a feature vector 410 of the first resolution feature 312 and a feature vector 420 of the second resolution feature 322 by using a pooling layer. The object tracking device 10 may generate the feature vector 410 of the first resolution feature 312 and the feature vector 420 of the second resolution feature 322 by using an average pooling technique.

The object tracking device 10 may generate an integrated feature vector 430 by integrating the feature vector 410 of the first resolution feature 312 and the feature vector 420 of the second resolution feature 322.

The object tracking device 10 may input the integrated feature vector 430 to a multi-layer perceptron (MLP) and may output specific time appearance information 440. Herein, the multi-layer perceptron may refer to a partial structure of a neural network including perceptron-based layers. Each layer may process input information and may pass the processed information to a next layer as an input value.

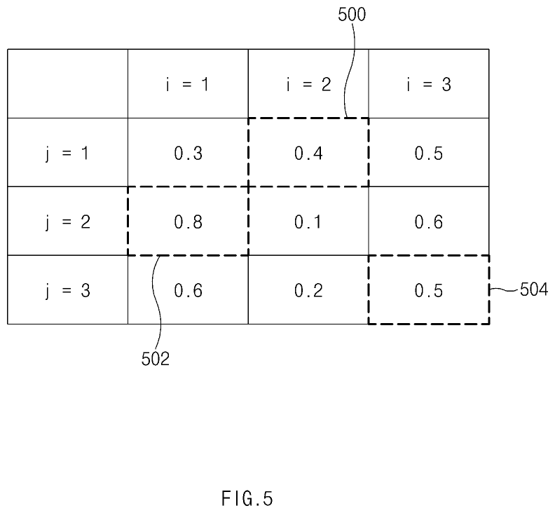

FIG. 5 shows an example of a cost matrix according to an example of the present disclosure.

Referring to FIG. 5, the object tracking device 10 may determine whether an interest object detected at a specific point in time is the same as a previously recognized object corresponding to past time appearance information at a past point in time.

The object tracking device 10 may generate a cost matrix, which a cost value is expressed for each of detected objects including the interest object, by using Equation 2 above.

The object tracking device 10 may determine whether an i-th object of the specific point in time is the same as a j-th object of the past point in time. The object tracking device 10 may determine whether the i-th object of the specific point in time is the same as the j-th object of the past point in time, based on the cost value. If the cost value is maximized, the object tracking device 10 may match the i-th object of the specific point in time and the j-th object of the past point in time. The object tracking device 10 may select cost values such that a plurality of rows “j” (=1, 2, and 3) correspond to a plurality of columns “i” (=1, 2, and 3) one-to-one. For example, if the object tracking device 10 selects 0.4 being a cost value 500 at the first row (j=1) and second column (i=2) of the matrix including the plurality of rows “j” (=1, 2, and 3) and the plurality of columns “i” (=1, 2, and 3), it is impossible to select 0.3 and 0.5 being the remaining cost values at the first row (j=1). Also, if the object tracking device 10 selects 0.4 being the cost value 500 corresponding to the second column (i=2), it is impossible to select 0.1 and 0.2 being the remaining cost values at the second column (i=2).

The object tracking device 10 may select cost values 500, 502, and 504 such that a sum of cost values of the i-th object of the specific point in time and the j-th object of the past point in time is maximized. For example, the object tracking device 10 may determine that a sum of 0.4 being the cost value 500 at the first row and second column, 0.8 being the cost value 502 at the second row and first column, and 0.5 being the cost value 504 at the third row and third column is the greatest. Accordingly, the object tracking device 10 may determine that the first object of the past point in time is the second object of the specific point in time, may determine that the second object of the past point in time is the first object of the specific point in time, and may determine that the third object of the past point in time is the third object of the specific point in time.

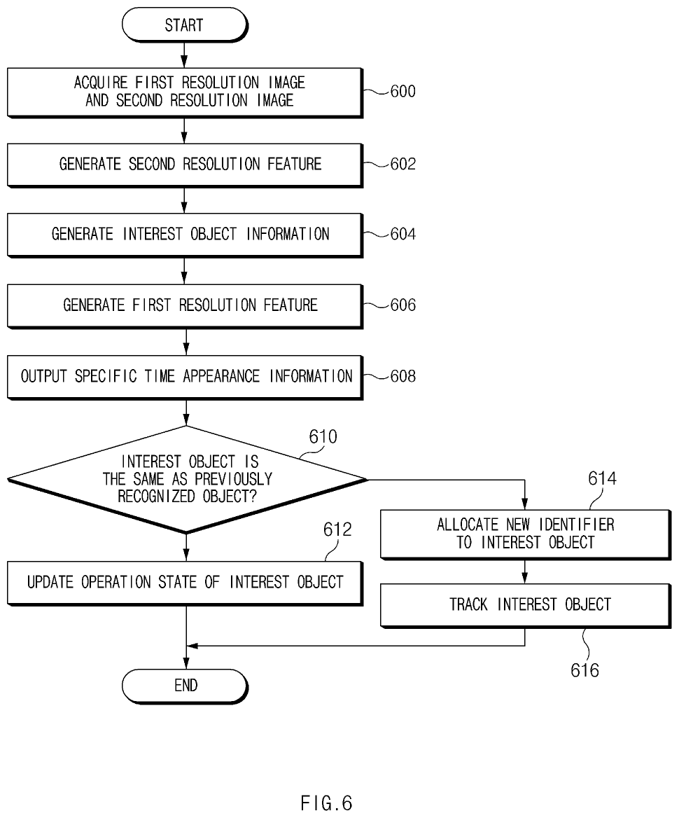

FIG. 6 shows an example of an operation method of the object tracking device 10 according to an example of the present disclosure.

Referring to FIG. 6, in operation 600, the first resolution image acquisition device 122 may acquire a first resolution image. The first resolution image acquisition device 122 may acquire the first resolution image at a specific point in time. The first resolution image acquisition device 122 may acquire the first resolution image captured around the vehicle by using the camera.

The second resolution image acquisition device 124 may acquire a second resolution image. The second resolution image acquisition device 124 may acquire the second resolution image corresponding to the first resolution image. The second resolution image acquisition device 124 may acquire the second resolution image at the specific point in time. The second resolution image acquisition device 124 may acquire an image of the second resolution that is lower in quality than the first resolution.

In an example, the second resolution image acquisition device 124 may acquire the second resolution image resolution by adjusting the resolution of the first resolution image. The second resolution image acquisition device 124 may acquire the second resolution image by adjusting the size of the first resolution image.

In an example, the second resolution image acquisition device 124 may acquire the second resolution image captured around the vehicle by using the camera.

In operation 602, the interest object information generator 126 may generate a second resolution feature associated with an interest object based on the second resolution image.

In operation 604, the interest object information generator 126 may generate interest object information including location information of the interest object based on the second resolution feature.

In operation 606, the first resolution feature generator 128 may generate a first resolution feature associated with a specific region in the first resolution image, which corresponds to the location information of the second resolution image. The first resolution feature generator 128 may generate the first resolution feature associated with the specific region in the first resolution image, which corresponds to a coordinate value of a bounding box including the interest object in the second resolution image.

In operation 608, the appearance information output device 130 may output appearance information of the interest object based on the first resolution feature and the second resolution feature. The appearance information output device 130 may output specific time appearance information of the interest object based on the first resolution feature and the second resolution feature.

In an example, the appearance information output device 130 may output the specific time appearance information by applying a pooling operation to the first resolution feature and the second resolution feature. In an example, the appearance information output device 130 may output the specific time appearance information by using an average pooling operation that is performed based on the first resolution feature and the second resolution feature. In an example, the appearance information output device 130 may output the specific time appearance information by using a max pooling operation that is performed based on the first resolution feature and the second resolution feature.

In operation 610, the object tracker 132 may determine whether the interest object is the same as a previously recognized object. The object tracker 132 may determine whether the interest object is the same as the previously recognized object, based on the similarity between the specific time appearance information and past time appearance information.

In an example, the object tracker 132 may determine whether the interest object is the same as the previously recognized object, based on an inner product of a feature vector of the specific time appearance information and a feature vector of the past time appearance information. The object tracker 132 may determine whether the interest object is the same as the previously recognized object, based on the cosine similarity between the feature vector of the specific time appearance information and the feature vector of the past time appearance information.

In an example, the object tracker 132 may determine whether the interest object is the same as the previously recognized object, based on a cost matrix. The object tracker 132 may determine whether the interest object is the same as the previously recognized object, based on the cost matrix including cost values that are based on at least one of the intersection over union (IoU), the Mahalanobis distance, and the cosine similarity.

If the interest object is the same as the previously recognized object, in operation 612, the object tracker 132 may update an operation state of the previously recognized object.

If the interest object is different from the previously recognized object or if there is no object recognized at the past point in time, in operation 614, the object tracker 132 may allocate a new identifier (ID) to the interest object.

In operation 616, the object tracker 132 may track an operation state of the interest object to which the new identifier is allocated.

The present disclosure has been made to solve the above-mentioned problems occurring in the prior art while advantages achieved by the prior art are maintained intact.

An example of the present disclosure provides an object tracking device and an operating method thereof capable of preventing switching of identifiers allocated to the plurality of objects even if the plurality of objects overlap each other, by further considering an appearance feature of an interest object acquired for each image frame.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an object tracking device may include a first resolution image acquisition device that acquires a first resolution image in which an interest object at a specific point in time is included, a second resolution image acquisition device that acquires a second resolution image corresponding to the first resolution image, an interest object information generator that generates a second resolution feature of the interest object based on the second resolution image and generates interest object information including location information of the interest object based on the second resolution feature, a first resolution feature generator that generates a first resolution feature associated with a specific region of the first resolution image, which corresponds to the location information, an appearance information output device that outputs specific time appearance information of the interest object at the specific point in time based on the first resolution feature and the second resolution feature, and an object tracker that tracks an operation state of the interest object based on the specific time appearance information and past time appearance information corresponding to a past point in time before the specific point in time.

In an example, the appearance information output device may output the specific time appearance information by applying a pooling operation to the first resolution feature and the second resolution feature.

In an example, the object tracker may determine whether the interest object is the same as a previously recognized object corresponding to the past time appearance information, based on similarity between the specific time appearance information and the past time appearance information, and may track the operation state of the interest object based on the determination result.

In an example, the object tracker may determine whether the interest object is the same as the previously recognized object, based on cosine similarity between the specific time appearance information and the past time appearance information.

In an example, the object tracker may determine whether the interest object is the same as the previously recognized object, based on at least one of an intersection over union (IoU), a Mahalanobis distance, and cosine similarity.

In an example, the object tracker may allocate a new identifier (ID) to the interest object if the interest object is different from the previously recognized object or if the previously recognized object does not exist, and may track the operation state of the interest object.

In an example, the second resolution image acquisition device acquires the second resolution image by adjusting a resolution of the first resolution image.

In an example, the specific region is a region in which a result of converting the location information based on a ratio of a size of the second resolution image to a size of the first resolution image is applied to the first resolution image.

According to an example of the present disclosure, an operating method an object tracking device may include acquiring a first resolution image in which an interest object at a specific point in time is included, acquiring a second resolution image corresponding to the first resolution image, generating a second resolution feature associated with the interest object based on the second resolution image, generating interest object information including location information of the interest object based on the second resolution feature, generating a first resolution feature associated with a specific region of the first resolution image, which corresponds to the location information, outputting specific time appearance information of the interest object at the specific point in time based on the first resolution feature and the second resolution feature, and tracking an operation state of the interest object based on the specific time appearance information and time past appearance information corresponding to a past point in time before the specific point in time.

In an example, the outputting of the specific time appearance information may include outputting the specific time appearance information by applying a pooling operation to the first resolution feature and the second resolution feature.

In an example, the method may further include determining whether the interest object is the same as a previously recognized object corresponding to the past time appearance information, based on similarity between the specific time appearance information and the past time appearance information. The tracking of the operation state of the interest object may include tracking the operation state of the interest object based on the determination result.

In an example, the determining whether the interest object is the same as the previously recognized object may include determining whether the interest object is the same as the previously recognized object, based on cosine similarity between the specific time appearance information and the past time appearance information.

In an example, the determining whether the interest object is the same as the previously recognized object may include determining whether the interest object is the same as the previously recognized object, based on at least one of an intersection over union (IoU), a Mahalanobis distance, and cosine similarity.

In an example, the method may further include allocating a new identifier (ID) to the interest object if the interest object is different from the previously recognized object or if it is determined that the previously recognized object does not exist.

In an example, the acquiring of the second resolution image may include acquiring the second resolution image by adjusting a resolution of the first resolution image.

In an example, the specific region may be a region in which a result of converting the location information based on a ratio of a size of the second resolution image to a size of the first resolution image is applied to the first resolution image.

The terms such as “comprise”, “include”, and “have” described above mean that the corresponding component may be included, unless there is a particularly contrary statement, and should be interpreted as further including another component, not excluding another component. Unless otherwise defined herein, all the terms used herein, which include technical or scientific terms, may have the same meaning that is generally understood by a person skilled in the art to which examples disclosed in the specification pertain. Terms commonly used, such as those defined in the dictionary, should be interpreted as having a meaning that is consistent with the meaning in the context of the related art and will not be interpreted as having an idealized or overly formal meaning unless expressly defined in in the specification.

According to various examples of the present disclosure, the object tracking device and the operating method thereof may reduce a resource by using a lower-resolution image.

According to various examples of the present disclosure, an object tracking device and an operating method thereof may extract a feature of an interest object from a higher-resolution image by using location information of a bounding box including an interest object of a lower-resolution image such that information loss that is caused if only the lower-resolution image used decreases.

According to various examples of the present disclosure, the object tracking device and the operating method thereof may further consider an appearance feature of an interest object acquired for each image frame, in addition or alternative to an IoU and a Mahalanobis distance, such that identifiers respectively allocated to a plurality of objects are not switched even if the plurality of objects overlap each other.

The effects of an object tracking device and an operating method thereof according to the disclosure of the specification are not limited to the effects mentioned above, and other effects not mentioned may be clearly understood by one skilled in the art based on the disclosure of the specification.

In the above, the specific example is illustrated and described. However, this is not limited to only the example. Those skilled in the art to which the present disclosure pertains will be able to make various changes without departing from the gist of the technical idea of the present disclosure as set forth in the claims below.

What is claimed is:

1. A device comprising:
a processor; and
memory storing instructions that, when executed by the processor, cause the device to:
receive a first resolution image associated with a first time and comprising an interest object;
generate, based on the first resolution image, a second resolution image;
determine, based on the second resolution image, a second resolution feature of the interest object;
determine, based on the second resolution feature, interest object information comprising location information of the interest object;
determine, based on the location information, a first resolution feature associated with a region of the first resolution image;
output, based on the first resolution feature and the second resolution feature, time appearance information indicating an appearance of the interest object associated with the first time;
track an operation state of the interest object based on the time appearance e information and past time appearance information, wherein the past time appearance information indicates an appearance of the interest object associated with a second time that is before the first time; and
output, based on the tracked operation state of the interest object, a signal to control operation of a second device.

2. The device of claim 1, wherein the instructions, when executed by the processor, cause the device to output the time appearance information by applying a pooling operation to the first resolution feature and the second resolution feature.

3. The device of claim 1, wherein the instructions, when executed by the processor, cause the device to:
determine, based on similarity between the time appearance information and the past time appearance information, whether the interest object is the same as a previously recognized object at the second time; and
track, based on the determination that the interest object is the same, the operation state of the interest object.

4. The device of claim 3, wherein the instructions, when executed by the processor, cause the device to:
determine, based on cosine similarity between the time appearance information and the past time appearance information, whether the interest object is the same as the previously recognized object.

5. The device of claim 3, wherein the instructions, when executed by the processor, cause the device to:
determine whether the interest object is the same as the previously recognized object, based on at least one of an intersection over union (IoU), a Mahalanobis distance, or cosine similarity.

6. The device of claim 3, wherein the instructions, when executed by the processor, cause the device to:
allocate a new identifier (ID) to the interest object based on the interest object being different from the previously recognized object or based on the interest object not being previously recognized; and
track, based on the new ID, the operation state of the interest object.

7. The device of claim 1, wherein the instructions, when executed by the processor, cause the device to:
acquire the second resolution image by adjusting a resolution of the first resolution image.

8. The device of claim 1, wherein the instructions, when executed by the processor, cause the device to:
determine, based on the location information and based on a ratio of a size of the second resolution image to a size of the first resolution image, the region of the first resolution image.

9. A method comprising:
receiving a first resolution image associated with a first time and comprising an interest object;
generating, based on the first resolution image, a second resolution image;
determining, based on the second resolution image, a second resolution feature associated with the interest object;
determining, based on the second resolution feature, interest object information comprising location information of the interest object;
determining, based on the location information, a first resolution feature associated with a region of the first resolution image;
outputting, based on the first resolution feature and the second resolution feature, time appearance information indicating an appearance of the interest object associated with the first time;
tracking an operation state of the interest object based on the time appearance information and past time appearance information, wherein the past appearance time information indicates an appearance of the interest object associated with a second time that is before the first time; and
outputting, based on the tracking the operation state of the interest object, a signal to control operation of a device.

10. The method of claim 9, wherein the outputting the time appearance information comprises:
applying a pooling operation to the first resolution feature and the second resolution feature.

11. The method of claim 9, further comprising:
determining, based on similarity between the time appearance information and the past time appearance information, whether the interest object is the same as a previously recognized object,
wherein the tracking the operation state of the interest object comprises:
tracking, based on the determining, the operation state of the interest object.

12. The method of claim 11, wherein the determining whether the interest object is the same as the previously recognized object comprises:
determining, based on cosine similarity between the time appearance information and the past time appearance information, whether the interest object is the same as the previously recognized object.

13. The method of claim 11, wherein the determining whether the interest object is the same as the previously recognized object comprises:
determining whether the interest object is the same as the previously recognized object, based on at least one of an intersection over union (IoU), a Mahalanobis distance, or cosine similarity.

14. The method of claim 11, further comprising:
allocating a new identifier (ID) to the interest object based on at least one of:
the interest object being different from the previously recognized object or
the interest object not being previously recognized.

15. The method of claim 9, wherein the receiving the second resolution image comprises:
adjusting a resolution of the first resolution image.

16. The method of claim 9, further comprising:
determining, based on the location information and based on a ratio of a size of the second resolution image to a size of the first resolution image, the region of the first resolution image.
